(19) United States
(12) Patent Application Publication
(10) Pub. No.: US 2020/0286014 A1
(43) Pub. Date: Sep. 10, 2020

(54) INFORMATION UPDATING METHOD AND DEVICE

(71) Applicants: Beijing Jingdong Century Trading Co., Ltd., Beijing (CN); BEIJINGJINGDONGSHANGKEINFORMATIONTECHNOLOGYCO,.LTD, Beijing (CN)

(72) Inventor: Qi Fang, Beijing (CN)

(21) Appl. No.: 16/652,436

(22) PCT Filed: Apr. 4, 2018
(86) PCT No.: PCT/CN2018/081955

§ 371 Date: Mar. 31, 2020

(30) Foreign Application Priority Data
Oct. 18, 2017 (CN) 201710969901.5

(51) Int. Cl. G06Q 10/06; G06F 16/23; G06F 16/2455; G06F 16/22; G06Q 50/28

(52) U.S. Cl. CPC G06Q 10/0635; G06F 16/2379; G06Q 50/28; G06F 16/2282; G06F 16/2455

(57) ABSTRACT

A method and an apparatus for updating information are provided. In the method, an order number of an order satisfying a target condition is periodically queried from an order detail information table, so as to generate order number sets divided according to stations and/or delivery staffs. Then, a queried order is determined as a risk order, and statistics of the order detail information of the determined risk order is performed, to generate the risk information corresponding to each generated order number set. Finally, a pre-stored risk information table is updated based on the risk information, and a pre-stored corresponding relationship information table is updated based on the corresponding relationship between the risk information number and the order numbers in the order number set.

### CROSS-REFERENCE TO RELATED APPLICATIONS

This patent application claims the priority from Chinese Application No. 201710969901.5, filed on Oct. 18, 2017 and titled “Apparatus for Updating Information,” the entire disclosure of which is hereby incorporated by reference.

### TECHNICAL FIELD

The present disclosure relates to the field of computer technology, specifically to the field of logistics, and particularly to a method and apparatus for updating information.

### BACKGROUND

In the field of logistics delivery, the goods related to an order will eventually be transported to a delivery station or a delivery staff. Therefore, it is necessary to monitor the orders of the delivery station, to ensure that delivering, returning, damage reporting and the like are properly implemented.

The existing approach is generally to scan all order detail information regularly, screen out and store detail information of a risk order. Since there are many fields of detail data and large amount of data in the order, a complicated processing process is required for updating the risk order, or determining whether the risk may be removed from the risk order, resulting in low flexibility in information updating.

### SUMMARY

The object of embodiments of the present disclosure is to propose an improved method and apparatus for updating information.

In a first aspect, the embodiments of the present disclosure provide a method for updating information. The method includes: querying periodically an order number of an order satisfying a target condition from an order detail information table, to generate order number sets divided according to stations and/or delivery staffs, order detail information in the order detail information table including an order number and at least one of a station number or a delivery staff number; determining the queried order as a risk order, and performing statistics of order detail information of the determined risk order, to generate risk information corresponding to each generated order number set, the risk information including a risk information number; and updating a pre-stored risk information table based on the generated risk information and updating a pre-stored corresponding relationship information table based on a corresponding relationship between the risk information number and order numbers in the order number set.

In some embodiments, the order detail information table is stored in a non-relational database, the risk information table is stored in a relational database, and the corresponding relationship information table is stored in a key-value database, the key-value database being a database organizing, indexing and storing data in a form of key-value pair.

In some embodiments, the risk information corresponding to each generated order number set further includes a station number and/or a delivery staff number corresponding to the each order number set, and each piece of original risk information recorded in the pre-stored risk information table includes an original station number and/or an original delivery staff number.

In some embodiments, the updating a pre-stored risk information table based on the generated risk information and updating a pre-stored corresponding relationship information table based on a corresponding relationship between the risk information number and order numbers in the order number set comprises: extracting the original station number and/or the original delivery staff number included in the each piece of original risk information recorded in the pre-stored risk information table, to generate a first number set; extracting the station number and/or the delivery staff number included in the risk information corresponding to the each generated order number set, to generate a second number set; and determining to-be-newly-created risk information, to-be-deleted risk information and to-be-replaced risk information in the risk information table and determining to-be-newly-created corresponding relationship information, to-be-deleted corresponding relationship information and to-be-replaced corresponding relationship information in the corresponding relationship information table based on a comparison between the first number set and the second number set, and updating the risk information table and the corresponding relationship information table.

In some embodiments, the determining to-be-newly-created risk information, to-be-deleted risk information and to-be-replaced risk information in the risk information table and determining to-be-newly-created corresponding relationship information, to-be-deleted corresponding relationship information and to-be-replaced corresponding relationship information in the corresponding relationship information table based on a comparison between the first number set and the second number set, and updating the risk information table and the corresponding relationship information table comprises: determining a union set of the first number set and the second number set; using a difference set between the second number set and the union set as a first difference set, and for each number in the first difference set, recording risk information corresponding to the each number and being included in the generated risk information into the risk information table, determining a risk information number corresponding to the each number, and recording corresponding relationship information between the determined risk information number and the order number into the corresponding relationship information table; using a difference set between the first number set and the union set as a second difference set, and for each number in the second difference set, determining a risk information number corresponding to the each number, deleting corresponding relationship information between the determined risk information number and the order number in the corresponding relationship information table, and deleting original risk information corresponding to the each number from the risk information table; and replacing, for each number in the union set, original risk information corresponding to the each number and being included in the risk information table with risk information corresponding to the each number and being included in the generated risk information, using a risk information number included in the risk information corresponding to the each number and being included in the generated risk information as a target risk information number, and replacing original corresponding relationship information between the risk information number and the order number, corresponding to the number and being included in the corresponding relationship information table, with corresponding relationship information for representing a corresponding relationship between the target risk information number and the order number.

In a second aspect, the embodiments of the present disclosure provide an apparatus for updating information. The apparatus includes: a querying unit, configured to periodically query an order number of an order satisfying a target condition from an order detail information table, to generate order number sets divided according to stations and/or delivery staffs, order detail information in the order detail information table including an order number and at least one of a station number or a delivery staff number; a statistics unit, configured to determine the queried order as a risk order, and perform statistics of order detail information of the determined risk order, to generate risk information corresponding to each generated order number set, the risk information including a risk information number; and an updating unit, configured to update a pre-stored risk information table based on the generated risk information and update a pre-stored corresponding relationship information table based on a corresponding relationship between the risk information number and order numbers in the order number set.

In some embodiments, the order detail information table is stored in a non-relational database, the risk information table is stored in a relational database, and the corresponding relationship information table is stored in a key-value database, the key-value database being a database organizing, indexing and storing data in a form of key-value pair.

In some embodiments, the risk information corresponding to each generated order number set further includes a station number and/or a delivery staff number corresponding to the each order number set, and each piece of original risk information recorded in the pre-stored risk information table includes an original station number and/or an original delivery staff number.

In some embodiments, the updating unit comprises: a first extracting module, configured to extract the original station number and/or the original delivery staff number included in the each piece of original risk information recorded in the pre-stored risk information table, to generate a first number set; a second extracting module, configured to extract the station number and/or the delivery staff number included in the risk information corresponding to the each generated order number set, to generate a second number set; and an updating module, configured to determine to-be-newly-created risk information, to-be-deleted risk information and to-be-replaced risk information in the risk information table and determine to-be-newly-created corresponding relationship information, to-be-deleted corresponding relationship information and to-be-replaced corresponding relationship information in the corresponding relationship information table based on a comparison between the first number set and the second number set, and update the risk information table and the corresponding relationship information table.

In some embodiments, the updating module comprises: a determining submodule, configured to determine a union set of the first number set and the second number set; a recording submodule, configured to use a difference set between the second number set and the union set as a first difference set, and for each number in the first difference set, record risk information corresponding to the each number and being included in the generated risk information into the risk information table, determine a risk information number corresponding to the number, and record corresponding relationship information between the determined risk information number and the order number into the corresponding relationship information table; a deleting submodule, configured to use a difference set between the first number set and the union set as a second difference set, and for each number in the second difference set, determine a risk information number corresponding to the each number, delete corresponding relationship information between the determined risk information number and the order number in the corresponding relationship information table, and delete original risk information corresponding to the each number from the risk information table; and a replacing submodule, configured to replace, for each number in the union set, original risk information corresponding to the each number and being included in the risk information table with risk information corresponding to the each number and being included in the generated risk information, use a risk information number included in the risk information corresponding to the each number and being included in the generated risk information as a target risk information number, and replace original corresponding relationship information between the risk information number and the order number, corresponding to the number and being included in the corresponding relationship information table, with corresponding relationship information for representing a corresponding relationship between the target risk information number and the order number.

In a third aspect, the embodiments of the present disclosure provide a server. The server includes: one or more processors; and a storage apparatus, configured to store one or more programs. The one or more programs, when executed by the one or more processors, cause the one or more processors to implement the method in any embodiment of the method for updating information.

In a fourth aspect, the embodiments of the present disclosure provide a computer readable storage medium storing a computer program. The program, when executed by a processor, implements the method in any embodiment of the method for updating information.

According to the method and apparatus for updating information provided by the embodiments of the present disclosure, the order number of the order satisfying the target condition is periodically queried from the order detail information table, so as to generate the order number sets divided according to the stations and/or the delivery staffs. Then, the queried order is determined as the risk order, and statistics of the order detail information of the determined risk order is performed, to generate the risk information corresponding to each generated order number set. Finally, the pre-stored risk information table is updated based on the risk information, and the pre-stored corresponding relationship information table is updated based on the corresponding relationship between the risk information number and the order numbers in the order number set. Thus, the risk information in the dimension of station and/or delivery staff may be obtained without storing all the detail information of the risk order, thereby reducing the amount of data storage. In addition, the information is updated based on the order detail information table, the risk information table and the corresponding relationship information table. In the case where the number of the fields in detail data of the order is large and the amount of the data is large, the data processing process for updating the risk order may be simplified, thus improving the flexibility in information updating.

### BRIEF DESCRIPTION OF THE DRAWINGS

After reading detailed descriptions for non-limiting embodiments given with reference to the following accompanying drawings, other features, objectives and advantages of the present disclosure will be more apparent:

FIG. 1 is a diagram of an example system architecture in which the present disclosure may be applied;

FIG. 2 is a flowchart of an embodiment of a method for updating information according to the present disclosure;

FIG. 3 is a schematic diagram of an application scenario of the method for updating information according to the present disclosure;

FIG. 4 is a flowchart of another embodiment of the method for updating information according to the present disclosure;

FIG. 5 is a schematic structural diagram of an embodiment of an apparatus for updating information according to the present disclosure; and

FIG. 6 is a schematic structural diagram of a computer system adapted to implement a server according to embodiments of the present disclosure.

### DETAILED DESCRIPTION OF EMBODIMENTS

The present disclosure will be described below in detail in conjunction with the accompanying drawings and the embodiments. It may be appreciated that the specific embodiments described herein are merely used for explaining the relevant invention, rather than limiting the invention. In addition, it should be noted that, for the ease of description, only the parts related to the relevant invention are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

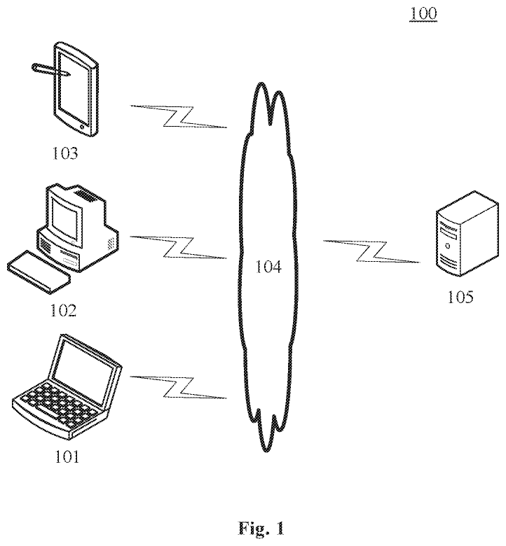

FIG. 1 shows an example system architecture 100 in which a method for updating information or an apparatus for updating information according to the present disclosure may be applied.

As shown in FIG. 1, the system architecture 100 may include terminal devices 101, 102 and 103 located at a station, a network 104 and a server 105. The network 104 serves as a medium providing a communication link between the terminal devices 101, 102 and 103 and the server 105. The network 104 may include various types of connections, for example, wired or wireless communication links, or optical fiber cables.

A logistics administrator may interact with the server 105 via the network 104 by using the terminal devices 101, 102 and 103, to receive or send information. Various communication client applications, such as a barcode scanning application and an order management application, may be installed on the terminal devices 101, 102 and 103.

The terminal devices 101, 102 and 103 may be various electronic devices having a display screen and supporting web page browsing, the electronic devices including, but not limited to, a tablet computer, a laptop portable computer, a desktop computer, etc.

The server 105 may be a server providing various services, for example, a monitoring server monitoring a status of an order. Various types of databases may be installed in the monitoring server, and the databases may store an order detail information table. The server 105 may periodically query an order from the order detail information table to determine a risk order, and update a risk information table and a corresponding relationship information table based on the risk order to implement the creation, deletion and update of the risk information.

It should be noted that the above order detail information table, the above risk information table and the above corresponding relationship information table may be stored in a local database, or may be stored in other databases (not shown in the drawings) connected to the above server.

It should be noted that the method for updating information provided by the embodiments of the present disclosure is generally performed by the server 105. Accordingly, the apparatus for updating information is generally arranged in the server 105.

It should be appreciated that the numbers of the terminal devices, the networks, and the servers in FIG. 1 are merely illustrative. Any number of terminal devices, networks and servers may be provided based on actual requirements.

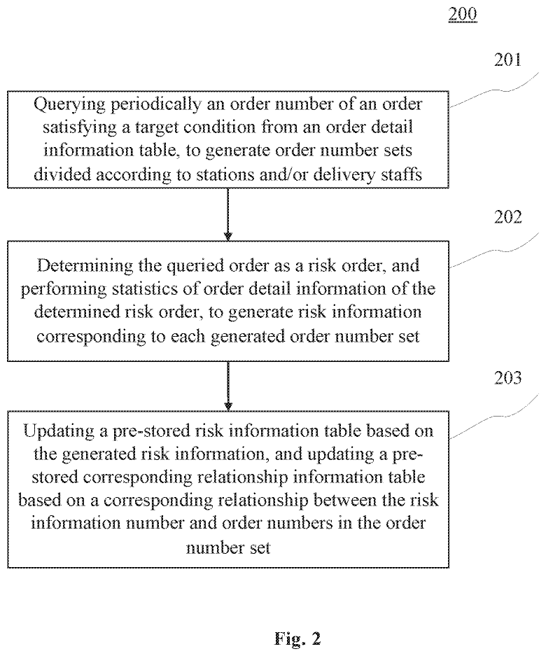

Further referring to FIG. 2, FIG. 2 illustrates a flow 200 of an embodiment of a method for updating information according to the present disclosure. The method for updating information includes the following steps:

Step 201, querying periodically an order number of an order satisfying a target condition from an order detail information table, to generate order number sets divided according to stations and/or delivery staffs.

In the embodiment, an electronic device (e.g., the server 105 shown in FIG. 1) on which the method for updating information is implemented may query periodically the order number of the order satisfying the target condition from the order detail information table, to generate the order number sets divided according to the stations and/or the delivery staffs. Here, the above target condition may be a condition preset by a technician based on a large amount of data statistics. The above target condition may be one or more conditions, and each target condition may correspond to an early-warning name. For each target condition, the above electronic device may perform a separate query and perform the following operations. As an example, the target condition corresponding to the early-warning name “a large-amount order being stranded and this procedure not being implemented” may be as follows: on the same day, an order amount of a single order is greater than a preset amount (e.g., 10,000 RMB Yuan), and after the station examines the goods, the delivery staff does not examine the goods, does not re-deliver the goods, does not refuse receipt, does not return the goods to the storehouse, does not successfully deliver the goods and does not report the damage, for more than a preset time length (e.g., 5 hours), and the payment method is on-line payment or payment on delivery. As another example, the target condition corresponding to the early-warning name “a mount of an order paid on delivery on the same day” may be as follows: on the same day, a single delivery staff examines the goods, but does not deliver goods, does not return the goods and does not report the damage, the payment method is payment on delivery, and the order amount is greater than a preset amount (e.g., 50,000 RMB Yuan).

It should be noted that the above order detail information in the order detail information table may include an order number and at least one of a station number or a delivery staff number. The above station number may be used for indicating and distinguishing a station, the above delivery staff number may be used for indicating and distinguishing a delivery staff, and the above station number and the above delivery staff number may be character strings composed of any character (e.g., a number or a letter). In addition, the order detail information may include other information related to an order, for example, an order amount, successful delivery time, redelivery time (empty if the order is not redelivered), rejection time (empty if the order is not refused by a recipient), payment method information, a station type, and sorting center shipment time.

It should be noted that since the order number sets are divided according to the stations and/or the delivery staffs, each generated order number set may correspond to the station number of one station or the delivery staff number of one delivery staff.

It should also be noted that the above order detail information table may be stored in the local database of the above electronic device, or may be stored in the database installed on another server connected to the above electronic device. The data in the above order detail information table may be updated in real time according to the order flow status. In practice, the terminal device (e.g., the terminal devices 101, 102 and 103) of each station may send data such as the successful delivery time and the redelivery time to the device on which the above database is installed, to update the order detail information table.

In some alternative implementations of the embodiment, the database storing the above order detail information table may be a non-relational database (NoSQL, Not Only Structured Query Language), such as Elasticsearch and hbase.

Step 202, determining the queried order as a risk order, and performing statistics of order detail information of the determined risk order, to generate risk information corresponding to each generated order number set, the risk information including a risk information number.

In the embodiment, the above electronic device may determine the queried order as the risk order, and performing statistics of the order detail information of the determined risk order, to generate the risk information corresponding to each generated order number set. Here, the risk information may include the risk information number, and the above risk information number may be used for indicating and distinguishing the risk information.

In addition, each piece of risk information may further include a quantity of risk orders involved in the order number set corresponding to the risk order, a sum of order amounts, risk generation time (e.g., the time at which the risk order is queried in step 201, the delivery time, the sorting center shipment time and the like may be determined as the risk generation time), risk removing time (which may be empty if the risk is not removed), a risk procedure name (e.g., “station procedure” and “delivery staff procedure”), a risk point field (e.g., “large-amount order” and “strand”), and the like.

It should be noted that since each generated order number set may correspond to the station number of one station or the delivery staff number of one delivery staff, and each generated order number set corresponds to one piece of risk information, each piece of risk information and each risk information number may correspond to one station number or one delivery staff number.

Step 203, updating a pre-stored risk information table based on the generated risk information, and updating a pre-stored corresponding relationship information table based on a corresponding relationship between the risk information number and order numbers in the order number set.

In the embodiment, the electronic device may update the pre-stored risk information table based on the generated risk information, and update the pre-stored corresponding relationship information table based on the corresponding relationship between the risk information number and the order numbers in the order number set. As an example, the electronic device may directly replace original risk information in the above risk information table with the above generated risk information, and may replace corresponding relationship information in the corresponding relationship information table with the corresponding relationship information for representing the corresponding relationship between the risk information number and the order numbers in the order number set.

It should be noted that the above risk information table and the corresponding relationship information table may be stored in a database installed locally in the electronic device, or may be respectively stored in databases installed in other electronic devices. The database storing the above risk information table and the database storing the above corresponding relationship information table may be various types of databases.

In some alternative implementations of the embodiment, the above risk information table may be stored in a relational database (e.g., a mysql or an oracle), and the above corresponding relationship information table may be stored in a key-value database (e.g., a redis or an ssdb). Here, the above key-value database may be a database that organizes, indexes and stores data in the form of key value pair.

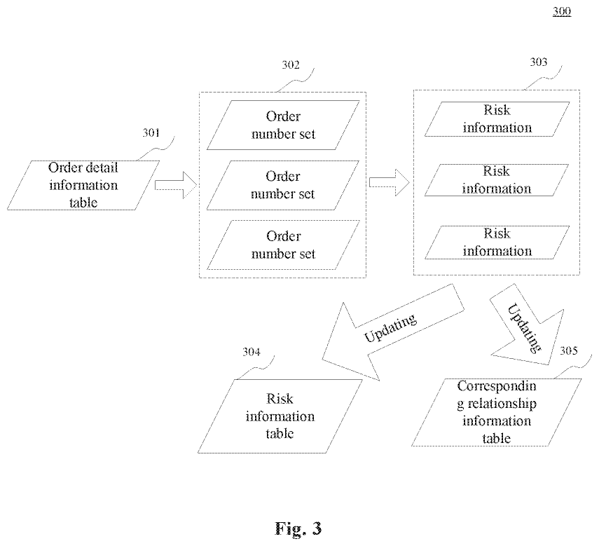

Further referring to FIG. 3, FIG. 3 is a schematic diagram of an application scenario of the method for updating information according to the embodiment. In the application scenario of FIG. 3, an order monitoring server may periodically query an order number of an order satisfying a target condition from an order detail information table 301, to generate order number sets 302 divided according to stations and/or delivery staffs. Then, the order monitoring server determines the queried order as a risk order, and performs statistics on order detail information of the determined risk order, to generate risk information 303 corresponding to each generated order number set. Finally, the order monitoring server updates a pre-stored risk information table 304 based on the generated risk information 303, and updates a pre-stored corresponding relationship information table 305 based on a corresponding relationship between a risk information number and order numbers in the order number set.

According to the method provided in the above embodiment of the present disclosure, the order number of the order satisfying the target condition is periodically queried from the order detail information table, so as to generate the order number set divided according to the stations and/or the delivery staffs. Then, the queried order is determined as the risk order, and statistics of the order detail information of the determined risk order is performed, to generate the risk information corresponding to each generated order number set. Finally, the pre-stored risk information table is updated based on the risk information, and the pre-stored corresponding relationship information table is updated based on the corresponding relationship between the risk information number and the order numbers in the order number set. Thus, the risk information in the dimension of station and/or delivery staff may be obtained without storing all the detail information of the risk order, thereby reducing the amount of data storage. In addition, the information is updated based on the order detail information table, the risk information table and the corresponding relationship information table. In the case where the number of the fields in detail data of the order is large and the amount of the data is large, the data processing process for updating the risk order may be simplified, thus improving the flexibility in information updating.

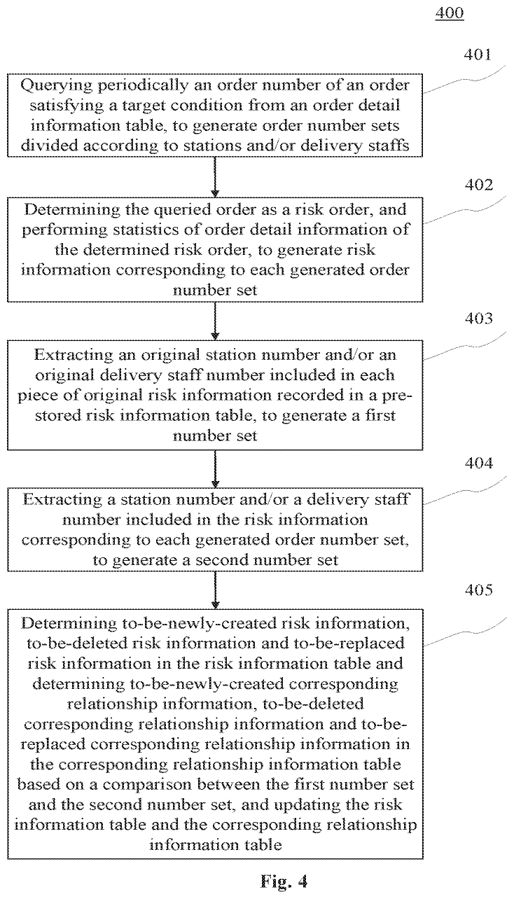

Further referring to FIG. 4, FIG. 4 illustrates a flow 400 of another embodiment of the method for updating information. The flow 400 of the method for updating information includes the following steps:

Step 401, querying periodically an order number of an order satisfying a target condition from an order detail information table, to generate order number sets divided according to stations and/or delivery staffs.

In this embodiment, an electronic device (e.g., the server 105 shown in FIG. 1) on which the method for updating information may query periodically the order number of the order satisfying the target condition from the order detail information table, to generate the order number sets divided according to the stations and/or the delivery staffs. The above order detail information table may be stored in a non-relational database (NoSQL, Not Only Structured Query Language), such as Elasticsearch or hbase. It should be noted that the above order detail information in the order detail information table may include an order number and at least one of a station number or a delivery staff number. It should be noted that since the order number sets are divided according to the stations and/or the delivery staffs, each generated order number set may correspond to the station number of one station or the delivery staff number of one delivery staff.

Step 402, determining the queried order as a risk order, and performing statistics of order detail information of the determined risk order, to generate risk information corresponding to each generated order number set, the risk information including a risk information number.

In this embodiment, the above electronic device may determine the queried order as the risk order, and performing statistics of the order detail information of the determined risk order, to generate the risk information corresponding to each generated order number set. Here, the risk information may include the risk information number. In addition, each piece of risk information may further include a quantity of risk orders involved in the order number set corresponding to the risk order, a sum of order amounts, risk generation time, risk removing time, a risk procedure name, a risk point field, and the like. It should be noted that since each generated order number set may correspond to the station number of one station or the delivery staff number of one delivery staff, and each generated order number set corresponds to one piece of risk information, each piece of risk information and each risk information number may correspond to one station number or one delivery staff number, and each risk information number corresponds to the order numbers in one order number set.

In the embodiment, the risk information corresponding to each generated order number set may further include the station number and/or the delivery staff number corresponding to this order number set.

Step 403, extracting an original station number and/or an original delivery staff number included in each piece of original risk information recorded in a pre-stored risk information table, to generate a first number set.

In the embodiment, each piece of original risk information recorded in the pre-stored risk information table may include the original station number and/or the original delivery staff number. The above electronic device may extract the original station number and/or the original delivery staff number included in each piece of original risk information recorded in the pre-stored risk information table, to generate the first number set. Here, the above risk information table may be stored in a relational database (e.g., a mysql or an oracle).

Step 404, extracting a station number and/or a delivery staff number included in the risk information corresponding to each generated order number set, to generate a second number set.

In the embodiment, the above electronic device may extract the station number and/or the delivery staff number included in the risk information corresponding to each order number set generated in step 402, to generate the second number set.

Step 405, determining to-be-newly-created risk information, to-be-deleted risk information and to-be-replaced risk information in the risk information table and determining to-be-newly-created corresponding relationship information, to-be-deleted corresponding relationship information and to-be-replaced corresponding relationship information in the corresponding relationship information table based on a comparison between the first number set and the second number set, and updating the risk information table and the corresponding relationship information table.

In the embodiment, the above electronic device may determine the to-be-newly-created risk information, the to-be-deleted risk information and the to-be-replaced risk information in the risk information table and determine the to-be-newly-created corresponding relationship information, the to-be-deleted corresponding relationship information and the to-be-replaced corresponding relationship information in the corresponding relationship information table based on the comparison between the first number set and the second number set, and update the risk information table and the corresponding relationship information table. Here, the above corresponding relationship information table may be stored in a key-value database (e.g., a redis or an ssdb).

Specifically, the above electronic device performs the following steps:

In a first step, the union set of the above first number set and the above second number set may be determined.

In a second step, the difference set between the above second number set and the above union set may be first used as a first difference set, and for each number in the above first difference set, the risk information corresponding to the number and being included in the generated risk information may be recorded in the above risk information table. Then, the risk information number corresponding to the number may be determined, and the corresponding relationship information between the determined risk information number and an order number may be recorded in the above corresponding relationship information table.

In a third step, the difference set between the above first number set and the above union set may be first used as a second difference set, and for each number in the above second difference set, the risk information number corresponding to the number is determined, and corresponding relationship information between the determined risk information number and an order number in the above corresponding relationship information table is deleted. Then, the original risk information corresponding to the number is deleted from the above risk information table.

In a fourth step, for each number in the above union set, the original risk information corresponding to the number and being included in the above risk information table may be first replaced with the risk information corresponding to the number and being included in the generated risk information. Then, the risk information number included in the risk information corresponding to the number and being included in the generated risk information is used as a target risk information number, and the original corresponding relationship information between the risk information number and an order number, corresponding to the number, in the above corresponding relationship information table is replaced with the corresponding relationship information for representing the corresponding relationship between the target risk information number and the order number.

It may be seen from FIG. 4 that, as compared with the embodiment corresponding to FIG. 2, the flow 400 of the method for updating information in the embodiment emphasizes the step of updating the risk information table and the corresponding relationship information table. Therefore, the scheme described in the embodiment can more flexibly update the risk information table and the corresponding relationship information table.

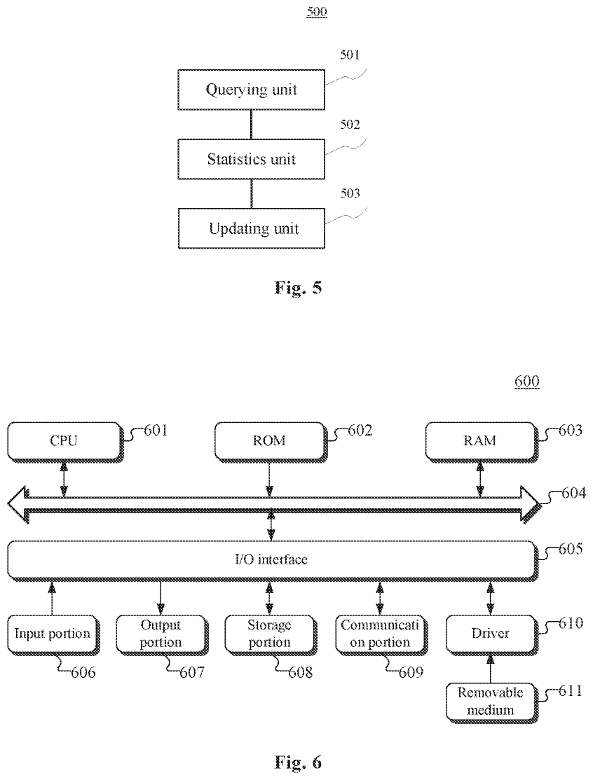

Further referring to FIG. 5, as an implementation of the method shown in the above figures, the present disclosure provides an embodiment of an apparatus for updating information. The embodiment of the apparatus corresponds to the embodiment of the method shown in FIG. 2, and the apparatus may be applied in various electronic devices.

As shown in FIG. 5, the above apparatus 500 for updating information in the embodiment includes: a querying unit 501, configured to periodically query an order number of an order satisfying a target condition from an order detail information table, to generate order number sets divided according to stations and/or delivery staffs, order detail information in the above order detail information table including an order number and at least one of a station number or a delivery staff number; a statistics unit 502, configured to determine the queried order as a risk order, and performing statistics of order detail information of the determined risk order, to generate risk information corresponding to each generated order number set, the above risk information including a risk information number; and an updating unit 503, configured to update a pre-stored risk information table based on the generated risk information and update a pre-stored corresponding relationship information table based on a corresponding relationship between the risk information number and order numbers in the order number set.

In the embodiment, the querying unit 501 may periodically query the order number of the order satisfying the target condition from the order detail information table, to generate the order number sets divided according to the stations and/or the delivery staffs. Here, the order detail information in the above order detail information table includes the order number and at least one of the station number or the delivery staff number.

In the embodiment, the statistics unit 502 may determine the queried order as the risk order, and perform statistics of the order detail information of the determined risk order, to generate the risk information corresponding to each generated order number set. Here, the above risk information may include the risk information number.

In the embodiment, the updating unit 503 may update the pre-stored risk information table based on the generated risk information and update the pre-stored corresponding relationship information table based on the corresponding relationship between the risk information number and the order numbers in the order number set.

In some alternative implementations of the embodiment, the above order detail information table is stored in a non-relational database, the above risk information table is stored in a relational database, and the above corresponding relationship information table is stored in a key-value database. Here, the above key-value database is a database organizing, indexing and storing data in a form of key-value pair.

In some alternative implementations of the embodiment, the risk information corresponding to each generated order number set further includes a station number and/or a delivery staff number corresponding to the order number set, and each piece of original risk information recorded in the pre-stored risk information table includes an original station number and/or an original delivery staff number.

In some alternative implementations of this embodiment, the above updating unit may include a first extracting module, a second extracting module, and an updating module (not shown in the figures). Here, the above first extracting module may be configured to extract the original station number and/or the original delivery staff number included in each piece of original risk information recorded in the pre-stored risk information table, to generate a first number set. The above second extracting module may be configured to extract the station number and/or the delivery staff number included in the risk information corresponding to each generated order number set, to generate a second number set. The above updating module may be configured to determine to-be-newly-created risk information, to-be-deleted risk information and to-be-replaced risk information in the above risk information table and determine to-be-newly-created corresponding relationship information, to-be-deleted corresponding relationship information and to-be-replaced corresponding relationship information in the above corresponding relationship information table based on a comparison between the above first number set and the above second number set, and update the above risk information table and the above corresponding relationship information table.

In some alternative implementations of the embodiment, the above updating module may include a determining submodule, a recording submodule, a deleting submodule and a replacing submodule (not shown in the drawing). Here, the determining submodule may be configured to determine a union set of the first number set and the second number set. The recording submodule may be configured to use a difference set between the second number set and the union set as a first difference set, and for each number in the first difference set, record risk information corresponding to the number and being included in the generated risk information into the above risk information table, determine a risk information number corresponding to the number, and record corresponding relationship information between the determined risk information number and an order number into the above corresponding relationship information table. The deleting submodule may be configured to use a difference set between the first number set and the union set as a second difference set, and for each number in the above second difference set, determine a risk information number corresponding to the number, delete corresponding relationship information between the determined risk information number and an order number in the above corresponding relationship information table, and delete original risk information corresponding to the number from the above risk information table. The replacing submodule may be configured to replace, for each number in above union set, original risk information corresponding to the number and being included in the above risk information table with risk information corresponding to the number and being included in the generated risk information, use a risk information number included in the risk information corresponding to the number and being included in the generated risk information as a target risk information number, and replace original corresponding relationship information between the risk information number and an order number, corresponding to the number and being included in the above corresponding relationship information table, with corresponding relationship information for representing a corresponding relationship between the target risk information number and the order number.

According to the apparatus provided by the above embodiment of the present disclosure, the querying unit 501 periodically queries the order number of the order satisfying the target condition from the order detail information table, so as to generate the order number sets divided according to the stations and/or the delivery staffs. Then, the statistics unit 502 determines the queried order as the risk order, and performs statistics of the order detail information of the determined risk order, to generate the risk information corresponding to each generated order number set. Finally, the updating unit 503 updates the pre-stored risk information table based on the generated risk information and updates the pre-stored corresponding relationship information table based on the corresponding relationship between the risk information number and the order numbers in the order number set. Thus, the risk information in the dimension of station and/or delivery staff may be obtained without storing all the detail information of the risk order, thereby reducing the amount of data storage. In addition, the information is updated based on the order detail information table, the risk information table and the corresponding relationship information table. In the case where the number of the fields in detail data of the order is large and the amount of the data is large, the data processing process for updating the risk order may be simplified, thus improving the flexibility in information updating.

Referring to FIG. 6, FIG. 6 is a schematic structural diagram of a computer system 600 adapted to implement a server of the embodiments of the present disclosure. The server shown in FIG. 6 is merely an example, and should not bring any limitations to the functions and the scope of the embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse, etc.; an output portion 607 including a cathode ray tube (CRT), a liquid crystal display device (LCD), a speaker, etc.; a storage portion 608 including a hard disk, etc.; and a communication portion 609 including a network interface card such as a LAN (local area network) card and a modem. The communication portion 609 performs communication processes via a network such as the Internet. A driver 610 is also connected to the I/O interface 605 as required. A removable medium 611 such as a magnetic disk, an optical disk, a magneto-optical disk, and a semiconductor memory may be installed on the driver 610 as needed, to facilitate the retrieval of a computer program from the removable medium 611, and the installation thereof on the storage portion 608 as needed.

In particular, according to embodiments of the present disclosure, the process described above with reference to the flow chart may be implemented as a computer software program. For example, an embodiment of the present disclosure includes a computer program product, including a computer program hosted on a computer readable medium, the computer program including program codes for performing the method as illustrated in the flowchart. In such an embodiment, the computer program may be downloaded and installed from a network via the communication portion 609, and/or may be installed from the removable medium 611. The computer program, when executed by the central processing unit (CPU) 601, implements the above mentioned functionalities defined in the method of the present disclosure. It should be noted that the computer readable medium in the present disclosure may be a computer readable signal medium, a computer readable storage medium, or any combination of the two. For example, the computer readable storage medium may be, but not limited to: an electronic, magnetic, optical, electromagnetic, infrared, or semiconductor system, apparatus, or element, or any combination of the above. A more specific example of the computer readable storage medium may include, but not limited to: an electrical connection having one or more wires, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs, which may be used by a command execution system, apparatus or element or incorporated thereto. In the present disclosure, the computer readable signal medium may include a data signal that is propagated in a baseband or as a part of a carrier wave, which carries computer readable program codes. Such propagated data signal may be in various forms, including, but not limited to, an electromagnetic signal, an optical signal, or any suitable combination of the above. The computer readable signal medium may also be any computer readable medium other than the computer readable storage medium. The computer readable medium is capable of transmitting, propagating or transferring programs for use by, or used in combination with, a command execution system, apparatus or element. The program codes contained on the computer readable medium may be transmitted with any suitable medium including, but not limited to, wireless, wired, optical cable, RF medium, or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units involved in the embodiments of the present disclosure may be implemented by means of software or hardware. The described units may also be provided in a processor. For example, the processor may be described as: a processor comprising a querying unit, a statistics unit and an updating unit. The names of these units do not in some cases constitute a limitation to such units themselves. For example, the querying unit may alternatively be described as “a unit for querying periodically an order number of an order satisfying a target condition from an order detail information table.”

In another aspect, the present disclosure further provides a computer readable medium. The computer readable medium may be the computer readable medium included in the apparatus described in the above embodiments, or a stand-alone computer readable medium not assembled into the apparatus. The above computer readable medium carries one or more programs. The above one or more programs, when executed by the apparatus, cause the apparatus to: periodically query an order number of an order satisfying a target condition from an order detail information table, to generate an order number set divided according to stations and/or delivery staffs, order detail information in the order detail information table including an order number and at least one of a station number or a delivery staff number; determine the queried order as a risk order, and perform statistics of order detail information of the determined risk order, to generate risk information corresponding to each generated order number set, the risk information including a risk information number; and update a pre-stored risk information table based on the generated risk information and update a pre-stored corresponding relationship information table based on a corresponding relationship between the risk information number and order numbers in the order number set.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

1. A method for updating information, comprising:
querying periodically an order number of an order satisfying a target condition from an order detail information table, to generate order number sets divided according to stations and/or delivery staffs, order detail information in the order detail information table including an order number and at least one of a station number or a delivery staff number;
determining the queried order as a risk order, and performing statistics of order detail information of the determined risk order, to generate risk information corresponding to each generated order number set, the risk information including a risk information number; and
updating a pre-stored risk information table based on the generated risk information and updating a pre-stored corresponding relationship information table based on a corresponding relationship between the risk information number and order numbers in the order number set.

2. The method for updating information according to claim 1, wherein the order detail information table is stored in a non-relational database, the risk information table is stored in a relational database, and the corresponding relationship information table is stored in a key-value database, the key-value database being a database organizing, indexing and storing data in a form of key-value pair.

3. The method for updating information according to claim 1, wherein the risk information corresponding to each generated order number set further includes a station number and/or a delivery staff number corresponding to the each order number set, and each piece of original risk information recorded in the pre-stored risk information table includes an original station number and/or an original delivery staff number.

4. The method for updating information according to claim 3, wherein the updating a pre-stored risk information table based on the generated risk information and updating a pre-stored corresponding relationship information table based on a corresponding relationship between the risk information number and order numbers in the order number set comprises:
extracting the original station number and/or the original delivery staff number included in the each piece of original risk information recorded in the pre-stored risk information table, to generate a first number set;
extracting the station number and/or the delivery staff number included in the risk information corresponding to the each generated order number set, to generate a second number set; and
determining to-be-newly-created risk information, to-be-deleted risk information and to-be-replaced risk information in the risk information table and determining to-be-newly-created corresponding relationship information, to-be-deleted corresponding relationship information and to-be-replaced corresponding relationship information in the corresponding relationship information table based on a comparison between the first number set and the second number set, and updating the risk information table and the corresponding relationship information table.

5. The method for updating information according to claim 4, wherein the determining to-be-newly-created risk information, to-be-deleted risk information and to-be-replaced risk information in the risk information table and determining to-be-newly-created corresponding relationship information, to-be-deleted corresponding relationship information and to-be-replaced corresponding relationship information in the corresponding relationship information table based on a comparison between the first number set and the second number set, and updating the risk information table and the corresponding relationship information table comprises:
determining a union set of the first number set and the second number set;
using a difference set between the second number set and the union set as a first difference set, and for each number in the first difference set, recording risk information corresponding to the each number and being included in the generated risk information into the risk information table, determining a risk information number corresponding to the each number, and recording corresponding relationship information between the determined risk information number and the order number into the corresponding relationship information table;
using a difference set between the first number set and the union set as a second difference set, and for each number in the second difference set, determining a risk information number corresponding to the each number, deleting corresponding relationship information between the determined risk information number and the order number in the corresponding relationship information table, and deleting original risk information corresponding to the each number from the risk information table; and
replacing, for each number in the union set, original risk information corresponding to the each number and being included in the risk information table with risk information corresponding to the each number and being included in the generated risk information, using a risk information number included in the risk information corresponding to the each number and being included in the generated risk information as a target risk information number, and replacing original corresponding relationship information between the risk information number and the order number, corresponding to the number and being included in the corresponding relationship information table, with corresponding relationship information for representing a corresponding relationship between the target risk information number and the order number.

6. An apparatus for updating information, comprising:
a processor and a memory storing computer readable instructions, wherein the instructions, when executed by the processor, cause the processor to perform operations, the operations comprising:
periodically querying an order number of an order satisfying a target condition from an order detail information table, to generate order number sets divided according to stations and/or delivery staffs, order detail information in the order detail information table including an order number and at least one of a station number or a delivery staff number;
determining the queried order as a risk order, and perform statistics of order detail information of the determined risk order, to generate risk information corresponding to each generated order number set, the risk information including a risk information number; and
updating a pre-stored risk information table based on the generated risk information and update a pre-stored corresponding relationship information table based on a corresponding relationship between the risk information number and order numbers in the order number set.

7. The apparatus for updating information according to claim 6, wherein the order detail information table is stored in a non-relational database, the risk information table is stored in a relational database, and the corresponding relationship information table is stored in a key-value database, the key-value database being a database organizing, indexing and storing data in a form of key-value pair.

8. The apparatus for updating information according to claim 6, wherein the risk information corresponding to each generated order number set further includes a station number and/or a delivery staff number corresponding to the each order number set, and each piece of original risk information recorded in the pre-stored risk information table includes an original station number and/or an original delivery staff number.

9. The apparatus for updating information according to claim 8, wherein the updating a pre-stored risk information table based on the generated risk information and updating a pre-stored corresponding relationship information table based on a corresponding relationship between the risk information number and order numbers in the order number set comprises:
extracting the original station number and/or the original delivery staff number included in the each piece of original risk information recorded in the pre-stored risk information table, to generate a first number set;
extracting the station number and/or the delivery staff number included in the risk information corresponding to the each generated order number set, to generate a second number set; and
determining to-be-newly-created risk information, to-be-deleted risk information and to-be-replaced risk information in the risk information table and determine to-be-newly-created corresponding relationship information, to-be-deleted corresponding relationship information and to-be-replaced corresponding relationship information in the corresponding relationship information table based on a comparison between the first number set and the second number set, and update the risk information table and the corresponding relationship information table.

10. The apparatus for updating information according to claim 9, wherein the determining to-be-newly-created risk information, to-be-deleted risk information and to-be-replaced risk information in the risk information table and determining to-be-newly-created corresponding relationship information, to-be-deleted corresponding relationship information and to-be-replaced corresponding relationship information in the corresponding relationship information table based on a comparison between the first number set and the second number set, and updating the risk information table and the corresponding relationship information table comprises comprises:
determining a union set of the first number set and the second number set;
using a difference set between the second number set and the union set as a first difference set, and for each number in the first difference set, record risk information corresponding to the each number and being included in the generated risk information into the risk information table, determine a risk information number corresponding to the number, and record corresponding relationship information between the determined risk information number and the order number into the corresponding relationship information table;
using a difference set between the first number set and the union set as a second difference set, and for each number in the second difference set, determine a risk information number corresponding to the each number, delete corresponding relationship information between the determined risk information number and the order number in the corresponding relationship information table, and delete original risk information corresponding to the each number from the risk information table; and
replacing, for each number in the union set, original risk information corresponding to the each number and being included in the risk information table with risk information corresponding to the each number and being included in the generated risk information, use a risk information number included in the risk information corresponding to the each number and being included in the generated risk information as a target risk information number, and replace original corresponding relationship information between the risk information number and the order number, corresponding to the number and being included in the corresponding relationship information table, with corresponding relationship information for representing a corresponding relationship between the target risk information number and the order number.

11. (canceled)

12. A non-transitory computer readable storage medium, storing a computer program, wherein the program, when executed by a processor, causes the processor to perform operations, the operation comprising:
querying periodically an order number of an order satisfying a target condition from an order detail information table, to generate order number sets divided according to stations and/or delivery staffs, order detail information in the order detail information table including an order number and at least one of a station number or a delivery staff number;
determining the queried order as a risk order, and performing statistics of order detail information of the determined risk order, to generate risk information corresponding to each generated order number set, the risk information including a risk information number; and
updating a pre-stored risk information table based on the generated risk information and updating a pre-stored corresponding relationship information table based on a corresponding relationship between the risk information number and order numbers in the order number set.

13. The computer readable storage medium according to claim 12, wherein the order detail information table is stored in a non-relational database, the risk information table is stored in a relational database, and the corresponding relationship information table is stored in a key-value database, the key-value database being a database organizing, indexing and storing data in a form of key-value pair.

14. The computer readable storage medium according to claim 12, wherein the risk information corresponding to each generated order number set further includes a station number and/or a delivery staff number corresponding to the each order number set, and each piece of original risk information recorded in the pre-stored risk information table includes an original station number and/or an original delivery staff number.

15. The computer readable storage medium according to claim 14, wherein the updating a pre-stored risk information table based on the generated risk information and updating a pre-stored corresponding relationship information table based on a corresponding relationship between the risk information number and order numbers in the order number set comprises:
extracting the original station number and/or the original delivery staff number included in the each piece of original risk information recorded in the pre-stored risk information table, to generate a first number set;
extracting the station number and/or the delivery staff number included in the risk information corresponding to the each generated order number set, to generate a second number set; and
determining to-be-newly-created risk information, to-be-deleted risk information and to-be-replaced risk information in the risk information table and determining to-be-newly-created corresponding relationship information, to-be-deleted corresponding relationship information and to-be-replaced corresponding relationship information in the corresponding relationship information table based on a comparison between the first number set and the second number set, and updating the risk information table and the corresponding relationship information table.

16. The computer readable storage medium according to claim 15, wherein the determining to-be-newly-created risk information, to-be-deleted risk information and to-be-replaced risk information in the risk information table and determining to-be-newly-created corresponding relationship information, to-be-deleted corresponding relationship information and to-be-replaced corresponding relationship information in the corresponding relationship information table based on a comparison between the first number set and the second number set, and updating the risk information table and the corresponding relationship information table comprises:
determining a union set of the first number set and the second number set;
using a difference set between the second number set and the union set as a first difference set, and for each number in the first difference set, recording risk information corresponding to the each number and being included in the generated risk information into the risk information table, determining a risk information number corresponding to the each number, and recording corresponding relationship information between the determined risk information number and the order number into the corresponding relationship information table;
using a difference set between the first number set and the union set as a second difference set, and for each number in the second difference set, determining a risk information number corresponding to the each number, deleting corresponding relationship information between the determined risk information number and the order number in the corresponding relationship information table, and deleting original risk information corresponding to the each number from the risk information table; and
replacing, for each number in the union set, original risk information corresponding to the each number and being included in the risk information table with risk information corresponding to the each number and being included in the generated risk information, using a risk information number included in the risk information corresponding to the each number and being included in the generated risk information as a target risk information number, and replacing original corresponding relationship information between the risk information number and the order number, corresponding to the number and being included in the corresponding relationship information table, with corresponding relationship information for representing a corresponding relationship between the target risk information number and the order number.
